(19) United States
(12) Patent Application Publication
(10) Pub. No.: US 2026/0241476 A1
(43) Pub. Date: Aug. 20, 2026

(54) ROBOT AND ROBOT WIRE FEEDER MOUNT

(71) Applicant: Deere & Company, Moline, IL (US)

(72) Inventors: TAYLOR G. HAU, Dubuque, IA (US); TANNER PATTERSON, Peosta, IA (US)

(21) Appl. No.: 19/057,159

(22) Filed: Feb. 19, 2025

(51) Int. Cl. B23K 9/133; B23K 37/02

(52) U.S. Cl. CPC B23K 9/133; B23K 37/0282

(57) ABSTRACT

A method for mounting and operating a wire feeder on a rotatable weld robot. Providing a first bracket coupled to at least one of a bottom portion of the rotatable weld robot or a stand supporting the weld robot. The first bracket extending radially outwardly from the bottom portion and the stand. Providing a second bracket coupled to the rotatable weld robot for rotation therewith, the second bracket comprising a wire feeder mount portion and at least one roller in communication with the first bracket, the wire feeder mount portion configured to receive a wire feeder, and the at least one roller configured to support the second bracket on the first bracket as the second bracket rotates with the rotatable weld robot. Rotating the rotatable weld robot through a full range of motion while supplying a weld wire from the wire feeder to the rotatable weld robot.

### TECHNICAL FIELD

The present disclosure relates generally to a rotatable weld robot, and more particularly to a wire feeder mount for a rotatable collaborative weld robot.

### BACKGROUND

Welding robots automate welding operations and are used in a wide variety of industries, typically requiring high volume production and repetitive welding. Robotic welders are often used in original equipment manufacturing industries such as automotive, agricultural, transportation, and construction vehicle industries. Industries other than vehicle manufacturing industries also employ welding robots to manufacture other types of products of varying sizes and shapes. One such industry is the agricultural equipment industry that manufactures apparatus for planting crops, fertilization, pest control, and harvesting.

In each of these industries, robotic welding typically includes holding one or more parts, and then welding those parts together to form a permanent bond. The welding process employed by a robotic welder includes arc welding, resistance welding, spot welding, GTAW welding, GMAW welding, laser welding, and plasma welding. In many industrial applications, a number of robotic work stations are arranged along a path taken by the apparatus being made, where each station is dedicated to perform a particular repetitive operation. Once the operation is completed at one of the work stations, the apparatus moves to another work station where additional welding operations are performed by another robotic welder.

The robotic welder is located in a work cell which is intended to prevent an individual from entering a work area where the welder performs its operations. In one type of welder, a robotic arm moves within the work area to apply welds to different locations on the structure being welded. The robotic arm includes a welding tip which guides the weld wire from a wire feeder to the material begin mated together. Due to the motion required by robotic arm the wire feeder needs to remain unobstructed and able to feed wire in a variety of positions.

A method for mounting and operating a wire feeder on a rotatable weld robot is disclosed. The method comprises providing a first bracket coupled to at least one of a bottom portion of the rotatable weld robot or a stand supporting the weld robot. The first bracket extending radially outwardly from the bottom portion and the stand to form a track. The method further comprises providing a second bracket coupled to the rotatable weld robot for rotation therewith. The second bracket comprising a wire feeder mount portion and at least one roller in communication with the first bracket, the wire feeder mount portion configured to receive a wire feeder, and the at least one roller configured to support the second bracket on the first bracket as the second bracket rotates with the rotatable weld robot. The method further yet comprises rotating the rotatable weld robot through a full range of motion while supplying a weld wire from the wire feeder to the rotatable weld robot.

A wire feeder mount for a rotatable weld robot is disclosed. The wire feeder mount comprises a first bracket coupled to at least one of a bottom portion of the rotatable weld robot or a stand supporting the rotatable weld robot. The first bracket extends radially outwardly from the bottom portion and the stand to form a track. A second bracket is coupled to the rotatable weld robot for rotation therewith. The second bracket comprises a wire feeder mount portion and at least one roller in communication with the track of the first bracket. The wire feeder mount portion is configured to receive a wire feeder and the at least one roller is configured to support the second bracket on the first bracket as the second bracket rotates with the rotatable weld robot through a full range of motion.

A rotatable collaborative weld robot is disclosed. The rotatable collaborative weld robot comprises a stand and a first rotatable joint coupled to the stand. The first rotatable joint is configured to rotate up to 360 degrees clockwise and counterclockwise relative to the stand. A second rotatable joint is coupled to the first rotatable joint. The second rotatable joint is configured to rotate relative to the first rotatable joint. A welding torch is coupled to the second rotatable joint. The welding torch is configured to weld. A wire feeder mount comprises a first bracket coupled to at least one of a bottom portion of the first rotatable joint of the rotatable collaborative weld robot or the stand supporting the rotatable collaborative weld robot. The first bracket extends radially outwardly from the bottom portion and the stand to form a track. A second bracket is coupled to the first rotatable joint of the rotatable collaborative weld robot for rotation therewith. The second bracket comprises a wire feeder mount portion and at least one roller in communication with the track of the first bracket. A wire feeder comprising a weld wire is coupled to the wire feeder mount portion. The at least one roller is configured to support the second bracket on the first bracket and enable the wire feeder to provide the weld wire to the rotatable collaborative weld robot as the second bracket rotates with the rotatable collaborative weld robot through a full range of motion.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a perspective view of a rotatable weld robot including a wire feeder mount according to one embodiment;

FIG. 2 is a perspective view of a nozzle of the rotatable weld robot of FIG. 1;

FIG. 3 is a perspective view of a rotatable collaborative weld robot; and

FIG. 4 is a flow chart of a method for mounting and operating a wire feeder on a rotatable weld robot.

Like reference numerals are used to indicate like elements throughout the several figures.

### DETAILED DESCRIPTION

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

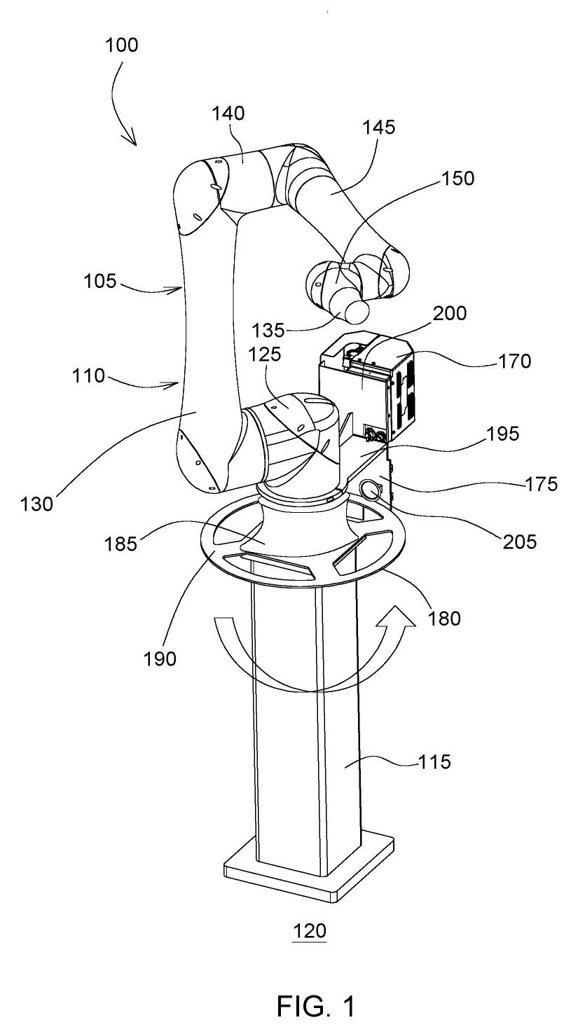

FIG. 1 illustrates one embodiment of a work cell including a rotatable weld robot 100 that may comprise a rotatable collaborative weld robot 105 comprising a robotic arm 110 that is coupled to a stand 115. The stand 115 may be fixed to and supported by a surface 120, such as a floor of a manufacturing facility. A first rotatable joint 125 is coupled to the stand 115. The first rotatable joint 125 is configured to rotate up to 360 degrees clockwise and counterclockwise relative to the stand 115. A second rotatable joint 130 is coupled to the first rotatable joint 125. The second rotatable joint 130 is configured to rotate relative to the first rotatable joint 125. The robotic arm 110 may include additional joints that rotate relative to one another to position a welding torch 135 at a variety of locations to weld one part to another part as is understood by one skilled in the art. In the embodiment shown, a third rotatable joint 140 is coupled to the second rotatable joint 130. A fourth rotatable joint 145 is coupled to the third rotatable joint 140. A fifth rotatable joint 150 is coupled to the fourth rotatable joint 145. The welding torch 135 is coupled to the fifth rotatable joint 150.

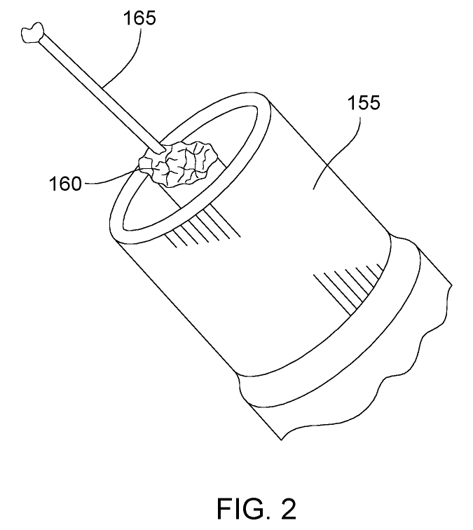

With reference to FIG. 2, the welding torch 135, in one embodiment, is an arc welding torch and includes a gas cup or nozzle 155 surrounding a tip 160. The nozzle 155 includes a plurality of threads, not shown, which are configured to engage threads of the welding torch 135 as is understood by one skilled in the art. The tip 160 includes threads, which are configured to engage threads of the welding torch 135 as is understood by one skilled in the art. The tip 160 includes an aperture at an end thereof through which a weld wire or wire 165 is fed through the robotic arm 110. During the welding process, the wire 165 is continuously fed though the tip 160 to form a weld on the material being welded. The wire 165, which is fed by a wire feeder 170 (see FIG. 1) such as a motor, is located at or near the robotic arm 110. If a weld forms at the tip 160, the wire 165 can no longer be fed through the aperture of the tip 160. The motor senses the lack of movement of the wire, for instance by a change in current being supplied by a power supply (not shown) coupled to the motor. Once the change in current is detected by the wire feeder 170, the wire feeder 170 is turned off so that the motor no longer attempts to deliver wire 165 through the nozzle 155. The wire feeder 170 may include a sensor to determine current being consumed by the motor.

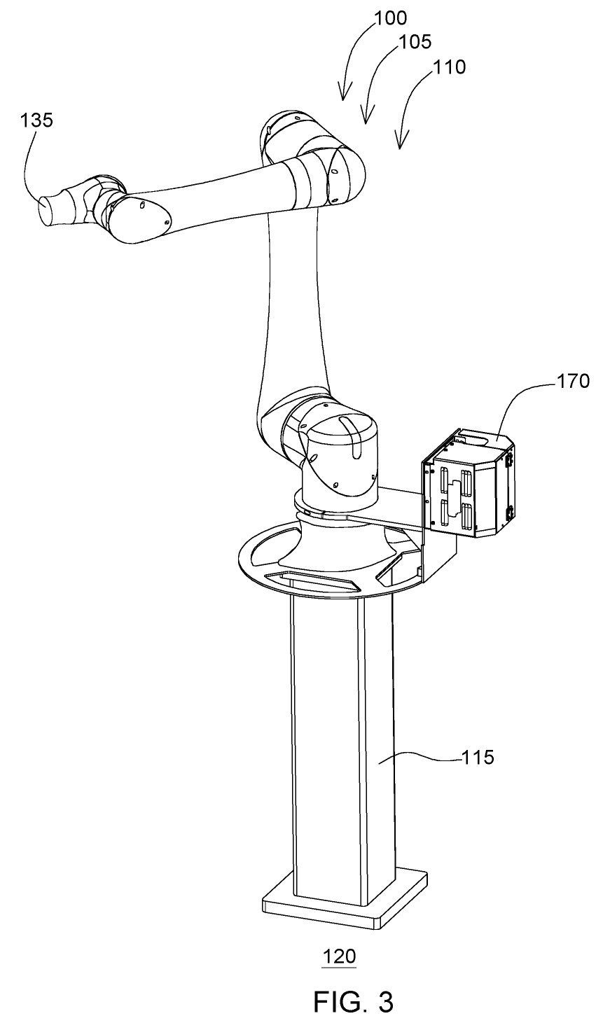

Referring to FIGS. 1 and 3, a wire feeder mount 175 supports the wire feeder 170. The wire feeder mount 175 comprises a first bracket 180 coupled to at least one of a bottom portion 185 of the first rotatable joint 125, or robot base, of the rotatable collaborative weld robot 105 or the stand 115 supporting the rotatable collaborative weld robot 105. The first bracket 180 extends radially outwardly from the bottom portion 185 and/or the stand 115 to form or define a track 190. A second bracket 195 is coupled to the first rotatable joint 125 of the rotatable collaborative weld robot 105 for rotation therewith. The second bracket 195 comprises a wire feeder mount portion 200 and at least one wheel or roller 205 in communication with the track 190 of the first bracket 180. The wire feeder 170 comprises the wire 165. The wire feeder 170 is coupled to the wire feeder mount portion 200. The at least one roller 205 is configured to support the second bracket 195 on the first bracket 180 and enable the wire feeder 170 to provide the wire 165 to the rotatable collaborative weld robot 105 as the second bracket 195 rotates with the rotatable collaborative weld robot 105 through a full range of motion (see the arrow of FIG. 1 indicating rotation).

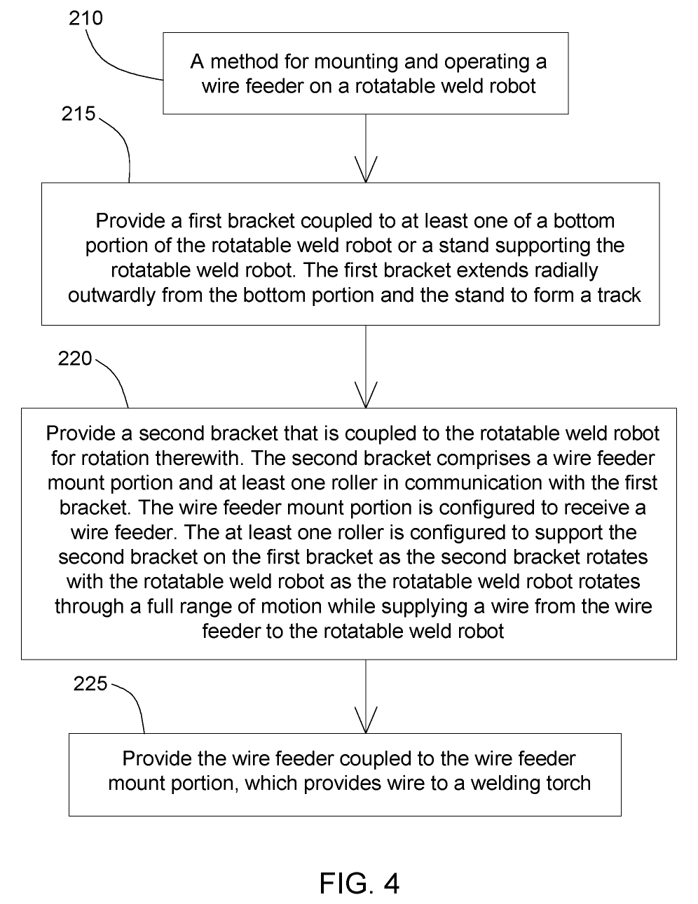

With reference to FIG. 4, a method 210 for mounting and operating a wire feeder 170 on a rotatable weld robot 100 is disclosed. In Step 215, the method comprises providing a first bracket 180 coupled to at least one of a bottom portion 185 of the rotatable weld robot 100 or a stand 115 supporting the rotatable weld robot 100. The first bracket 180 extends radially outwardly from the bottom portion 185 and the stand 115 to form a track 190. In Step 220, a second bracket 195 is provided that is coupled to the rotatable weld robot 100 for rotation therewith. The second bracket 195 comprises a wire feeder mount portion 200 and at least one roller 205 in communication with the first bracket 180. The wire feeder mount portion 200 is configured to receive a wire feeder 170. The at least one roller 205 is configured to support the second bracket 195 on the first bracket 180 as the second bracket 195 rotates with the rotatable weld robot 100 as the rotatable weld robot 100 rotates through a full range of motion while supplying a wire 165 from the wire feeder 170 to the rotatable weld robot 100. In Step 225, the wire feeder 170 is coupled to the wire feeder mount portion 200 and provides wire 165 to the welding torch 135.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for mounting and operating a wire feeder on a rotatable weld robot, the method comprising:
providing a first bracket coupled to at least one of a bottom portion of the rotatable weld robot or a stand supporting the rotatable weld robot; the first bracket extending radially outwardly from the bottom portion and the stand to form a track;
providing a second bracket coupled to the rotatable weld robot for rotation therewith, the second bracket comprising a wire feeder mount portion and at least one roller in communication with the first bracket, the wire feeder mount portion configured to receive a wire feeder, and the at least one roller configured to support the second bracket on the first bracket as the second bracket rotates with the rotatable weld robot; and
rotating the rotatable weld robot through a full range of motion while supplying a weld wire from the wire feeder to the rotatable weld robot.

2. The method of claim 1, wherein the rotatable weld robot comprises a rotatable collaborative weld robot.

3. The method of claim 1, further comprising supplying a weld wire to the wire feeder from a weld wire supply while enabling the rotatable weld robot to rotate up to 360 degrees clockwise and counterclockwise.

4. The method of claim 1, further comprising providing the wire feeder comprising the weld wire, the wire feeder coupled to the wire feeder mount portion, the at least one roller is configured to support the second bracket on the first bracket and enable the wire feeder to provide the weld wire to the rotatable weld robot as the second bracket rotates with the rotatable weld robot up to 360 degrees clockwise or counterclockwise.

5. The method of claim 1, wherein the at least one roller comprises at least one wheel that is in contact with the track.

6. The method of claim 1, wherein the second bracket defines a routing path for at least one of a power cable or a weld wire from a weld wire supply.

7. The method of claim 1, further comprising providing at least one of an aperture and a cutout in the second bracket for receiving a weld wire for the wire feeder.

8. A wire feeder mount for a rotatable weld robot, the wire feeder mount comprising:
a first bracket coupled to at least one of a bottom portion of the rotatable weld robot or a stand supporting the rotatable weld robot, the first bracket extending radially outwardly from the bottom portion and the stand to form a track;
a second bracket coupled to the rotatable weld robot for rotation therewith, the second bracket comprising a wire feeder mount portion and at least one roller in communication with the track of the first bracket, the wire feeder mount portion configured to receive a wire feeder and the at least one roller configured to support the second bracket on the first bracket as the second bracket rotates with the rotatable weld robot through a full range of motion.

9. The wire feeder mount of claim 8, wherein the rotatable weld robot comprises a rotatable collaborate weld robot.

10. The wire feeder mount of claim 8, wherein the at least one roller comprises at least one wheel that is in contact with the track.

11. The wire feeder mount of claim 8, further comprising at least one of an aperture and a cutout in the second bracket for receiving a weld wire for the wire feeder.

12. The wire feeder mount of claim 8, wherein the second bracket defines a routing path to the wire feeder for at least one of a power cable and a weld wire from a weld wire supply.

13. The wire feeder mount of claim 8, further comprising at least one of an aperture or a cutout in the first bracket for receiving a rotatable weld robot power cable.

14. The wire feeder mount of claim 8, wherein the first bracket defines a rotatable weld robot routing path to the rotatable weld robot for a rotatable weld robot power cable.

15. A rotatable collaborative weld robot comprising:
a stand;
a first rotatable joint coupled to the stand, the first rotatable joint configured to rotate up to 360 degrees clockwise and counterclockwise relative to the stand;
a second rotatable joint coupled to the first rotatable joint, the second rotatable joint configured to rotate relative to the first rotatable joint;
a welding torch coupled to the second rotatable joint, the welding torch configured to weld; and
a wire feeder mount comprising:
a first bracket coupled to at least one of a bottom portion of the first rotatable joint of the rotatable collaborative weld robot or the stand supporting the rotatable collaborative weld robot, the first bracket extending radially outwardly from the bottom portion and the stand to form a track;
a second bracket coupled to the first rotatable joint of the rotatable collaborative weld robot for rotation therewith, the second bracket comprising a wire feeder mount portion and at least one roller in communication with the track of the first bracket; and
a wire feeder comprising a weld wire, the wire feeder coupled to the wire feeder mount portion, the at least one roller is configured to support the second bracket on the first bracket and enable the wire feeder to provide the weld wire to the rotatable collaborative weld robot as the second bracket rotates with the rotatable collaborative weld robot through a full range of motion.

16. The rotatable collaborative weld robot of claim 15, further comprising a third rotatable joint coupled between the first rotatable joint and the second rotatable joint.

17. The rotatable collaborative weld robot of claim 15, further comprising a weld wire supply in communication with the wire feeder to supply wire thereto.

18. The rotatable collaborative weld robot of claim 15, wherein the at least one roller comprises a wheel.

19. The rotatable collaborative weld robot of claim 15, wherein the second bracket defines a routing path for at least one of a power cable and a weld wire from a weld wire supply.

20. The rotatable collaborative weld robot of claim 15, further comprising a means to supply weld wire to the wire feeder that enables the rotatable collaborative weld robot to rotate up to 360 degrees clockwise or counterclockwise.
